(19) United States
(12) Patent Application Publication
(10) Pub. No.: US 2017/0149724 A1
(43) Pub. Date: May 25, 2017

(54) AUTOMATIC GENERATION OF SOCIAL MEDIA MESSAGES REGARDING A PRESENTATION

(71) Applicant: International Business Machines Corporation, Armonk, NY (US)

(72) Inventor: Gregory R. Hintermeister, Rochester, MN (US)

(21) Appl. No.: 14/951,833

(22) Filed: Nov. 25, 2015

(51) Int. Cl. H04L 12/58

(52) U.S. Cl. CPC H04L 51/32; H04L 51/043

(57) ABSTRACT

Content being presented to an audience can be automatically monitored in real time. The content can include a plurality of content portions. Responsive to identifying presentation of the content advancing from a first portion of the content to a second portion of the content, whether at least one element of the second portion of the content is assigned a tag can be automatically determined. Responsive to determining that the at least one element of the second portion of the content is assigned the tag, a first social media message including the at least one element of the second portion of the content that assigned the tag can be automatically generated in real time. The first social media message can be automatically communicated, in real time, to at least one social media system for sharing with people.

### BACKGROUND

The present invention relates to social media systems, and more specifically, to communicating social media messages.

Social media is a collective of online communications channels dedicated to community-based input, interaction, content-sharing and collaboration. Websites and applications dedicated to forums, microblogging, social networking, social bookmarking, social curation, and wikis are among the different types of social media. Social media is becoming an integral part of life online as social websites and applications proliferate. Most traditional online media include social components, such as comment fields for users. In business, social media is used to market products, promote brands, connect to customers and foster new business.

### SUMMARY

A method includes automatically monitoring, in real time, content being presented to an audience, the content including a plurality of content portions. The method also can include, responsive to identifying presentation of the content advancing from a first portion of the content to a second portion of the content, automatically determining, by a processor in real time, whether at least one element of the second portion of the content is assigned a tag. The method also can include, responsive to determining that the at least one element of the second portion of the content is assigned the tag, automatically generating, in real time, a first social media message including the at least one element of the second portion of the content that assigned the tag. The method also can include automatically communicating, in real time, via at least one communication network, the first social media message to at least one social media system for sharing with people.

A system includes a processor programmed to initiate executable operations. The executable operations include automatically monitoring, in real time, content being presented to an audience, the content including a plurality of content portions. The executable operations also can include, responsive to identifying presentation of the content advancing from a first portion of the content to a second portion of the content, automatically determining, in real time, whether at least one element of the second portion of the content is assigned a tag. The executable operations also can include, responsive to determining that the at least one element of the second portion of the content is assigned the tag, automatically generating, in real time, a first social media message including the at least one element of the second portion of the content that assigned the tag. The executable operations also can include automatically communicating, in real time, via at least one communication network, the first social media message to at least one social media system for sharing with people.

A computer program includes a computer readable storage medium having program code stored thereon. The program code is executable by a processor to perform a method. The method includes automatically monitoring, by the processor in real time, content being presented to an audience, the content including a plurality of content portions. The method also can include, responsive to identifying presentation of the content advancing from a first portion of the content to a second portion of the content, automatically determining, by the processor in real time, whether at least one element of the second portion of the content is assigned a tag. The method also can include, responsive to determining that the at least one element of the second portion of the content is assigned the tag, automatically generating, by the processor in real time, a first social media message including the at least one element of the second portion of the content that assigned the tag. The method also can include automatically communicating, by the processor in real time, via at least one communication network, the first social media message to at least one social media system for sharing with people.

### BRIEF DESCRIPTION OF THE DRAWINGS

FIG. 1 is a pictorial diagram illustrating an example of a portion of content including various elements.

FIG. 2 is a block diagram illustrating an example of a network data processing system.

FIG. 3 is a flow chart illustrating an example of a method of communicating a social media message relating to content being presented to an audience.

FIG. 4 is a block diagram illustrating example architecture for a data processing system.

### DETAILED DESCRIPTION

Arrangements described herein relate to social media systems, and more specifically, to communicating social media messages. In accordance with the inventive arrangements disclosed herein, social media messages pertaining to content being presented to an audience can be automatically generated and shared with other people. For example, while a user generates content for a presentation, the user can tag elements within the content for inclusion in one or more social media messages. Further, the user can specify parameters indicating when the social media messages are to be generated and communicated. At the specified times, which may be specific times or times that are relative to certain events, social media messages including one or more of the tagged elements can be automatically generated and communicated to social media systems for sharing with various people. Thus, rather than generating the content and separately generating social media messages pertaining to the content, the user can, within the content itself, select elements to include within different social media messages and schedule when those social media messages are communicated. This can save a user who is responsible for generating content and social media messages a significant amount of time, while also conserving system resources. For example, rather than storing a number of different social media messages a priori, a processing system can generate and communicate the social media messages in real time, which can result in reduced usage of storage capacity on the processing system.

Several definitions that apply throughout this document now will be presented.

As defined herein, the term “content” means text, images, video and/or links to other text, images and/or video that is configured to be presented to an audience. For example, the content can be included in an electronic presentation that includes a series of pages or slides, the content can be included in a multimedia presentation (e.g., a video), or the like.

As defined herein, the term “element” means a particular word, sentence, paragraph, page, link, image or video contained within content.

As defined herein, the term “tag” means information used as a label or marker of at least one element contained within content that is distinct from the actual element(s).

As defined herein, the term “social media message” means a message configured to be communicated to a social media system and shared with one or more people who subscribe to the social media system. A social media message can be, for example, a post to a social media website.

As defined herein, the term “social media system” means a system that provides one or more social media services, for instance via one or more websites. A social media service is an online service platform on which social networks or social relations are built among people who, for example, share interests, activities, backgrounds or real-life connections, and via which people can share information with one another.

As defined herein, the term “client device” means a processing system including at least one processor and memory that requests shared services from a server, and with which a user directly interacts. Examples of a client device include, but are not limited to, a workstation, a desktop computer, a mobile computer, a laptop computer, a netbook computer, a tablet computer, a smart phone, a digital personal assistant, a smart watch, smart glasses, a gaming device, a set-top box and the like. Network infrastructure, such as routers, firewalls, switches, and the like, are not client devices as the term “client device” is defined herein.

As defined herein, the term “presentation device” means a processing system including at least one processor and memory configured to present content. A presentation device can be, for example, a client device executing one or more applications suitably configured to present content. In one arrangement, the presentation device can couple to a display, projector, audio system, or other devices or systems via which the presentation device presents the content. In another arrangement, the presentation device can present the content by communicating the content for presentation via one or more networks, such as the Internet.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

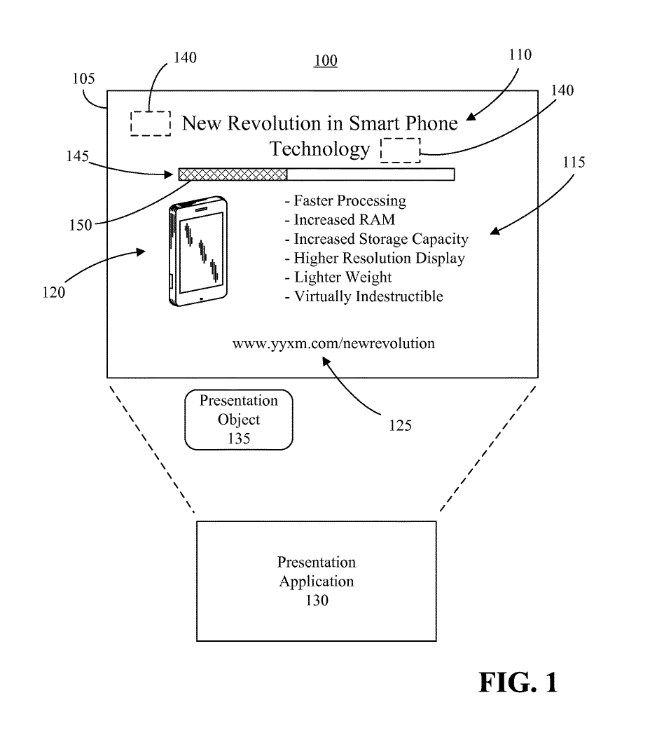

FIG. 1 is a pictorial diagram illustrating an example of a portion 105 (e.g., a page or slide) 100 of content including various elements 110, 115, 120, 125. The elements 105-120 can include, for example, a title 110, descriptive information (e.g., bullet points) 115, one or more images or videos 120, one or more links (e.g., uniform resource locators) 125, or the like. The content 100 can be configured for presentation to an audience. For example, the content 100 can be configured to be presented to a live audience or streamed to audience members over one or more communication networks, such as the Internet.

A user can generate the content 100 using a presentation application 130 configured to be used by users to generate content for presentations. Further, the user can use a presentation object 135 to assign tags 140 to one or more of the elements 110-125. For example, the presentation object 135 can include one or more user selectable menu items the user may select to tag one or more elements 110-125. The presentation object 135 can be configured to operate with any number of different presentation applications, including the presentation application 130.

In one arrangement, the presentation object 135 can be software embedded within a file for the content 100. For example, the presentation application 130 can generate the presentation object 135 responsive to the user initiating creation of the content 100 or responsive to the user selecting a corresponding menu item. In another arrangement, the presentation object 135 can be a plugin to the presentation application 130. In yet another arrangement, the presentation object 135 can be a stand-alone application, for example an application executed by a server. In such an arrangement, the user can access the presentation object 135 using a client device executing the presentation application 130 when creating or editing the content 100. In arrangements in which the presentation object 135 is embedded in the file for the content 100 or accessible from a server, the user can open the content 100 using any other suitable application, while still having the ability to assign tags 140, edit tag types/parameters, etc.

In one aspect, the presentation object 135 can be configured to identify elements within the content 100, and provide to the user recommendations of elements the user may consider tagging. For example, the presentation object 135 can identify headings, bullet points, key messages, uniform resource locators, images/video, or the like. The presentation object 135 can, responsive to identifying such elements, present to the user indicators prompting the user to assign tags 140 to those elements.

In the example depicted in FIG. 1, the user can assign a tag 140 to the element 110. The tag 140 can include a first part that identifies the beginning of the element 110 and a second part that identifies the end of the element 110. During presentation of the content 100, the tag 140 need not be displayed on the portion 105 of the content 100. For example, the tag 140 can be implemented as metadata. Nonetheless, the presentation application 130 can present the tag 140 to the user while the user is creating or editing the content 100, thus indicating to the user that the element 110 has been tagged. In another arrangement, the presentation application 130 can present some other type of indication to the user to indicate that the element 110 has been tagged, for example highlighting of the element 110, underlining of the element, or the like.

Responsive to the user assigning the tag 140 to the element 110, the presentation application 130 or the presentation object 135 can prompt the user to assign a tag type and/or provide additional parameters for the tag, for example by presenting a menu with fields configured to receive corresponding user inputs. The user can enter or select the desired tag type and/or parameters. For example, the user can assign a tag type “social media” to the tag 140. The “social media” tag type can indicate that the element 110 is to be included in a social media message that is automatically generated and communicated. Further, the user can enter a parameter indicating which of a plurality of social media systems to which the social media message or messages is to be communicated for sharing with various people. The user also can enter a parameter indicating an entity to identify as a sender of the social media message. The user also can enter a parameter indicating whether the element 110 is to be analyzed based on feedback, which is described herein in further detail. The user also can enter additional information to include in the social media message.

Further, the user can assign parameters to the tag 140 indicating when the social media message is to be generated and communicated. For example, the user can assign a parameter indicating that the social media message is to be automatically generated and communicated when the user advances to the portion 105 of the content 100 during a presentation. In another example, the user can assign a parameter indicating that the social media message is to be automatically generated and communicated at a pre-determined time, or at a time that is a predetermined duration of time prior to a time when the presentation of the content to the audience is scheduled to begin. In a further example, the user can assign a parameter indicating that the social media message is to be automatically generated and communicated upon completion of the presentation of the content, or at a time that is a predetermined duration of time after a time when completion of the presentation of the content to the audience is identified.

In view of the foregoing, the user can tag various elements 110-125, as well as elements of other portions of the content 100, and have the different elements included in various social media messages that are automatically generated and communicated at different times. Further, the user also can assign a parameter associating the tag 140 with one or more other tags, for example as a tag group. Each tag within the tag group can be included in the same social media message.

In one arrangement, the presentation object 135 can include and present to the user a timeline indicating each tag and/or tag group and when social media messages are scheduled to be automatically generated and communicated for each tag/tag group. The user can interact with the timeline to make changes to such scheduling, for example to change times when social media messages are generated and communicated. Further, the user can interact with the timeline to add tags to tag groups, remove tags from tag groups, delete tags, or the like. Also, in the timeline, the user can indicate when presentation of the content 100 is to begin. The user can update the timeline to change that time if so needed. Further, in the timeline the user also can define social media messages to be communicated which may or may not include elements of the content 100, and when such social media messages are to be communicated. Although the elements 110-125 of the content 100 may not be specified for such social media messages, the user can specify information relating to the content 100 to be included in such social media messages.

In one aspect of the present arrangements, the user can assign a social media status indicator 145 to one or more of the elements 110-125 assigned a tag 140. The social media status indicator 145 can be depicted in the portion 105 of the content 100 in a manner indicating that the social media status indicator 145 is related to one or more of the element 110-125 that are assigned the tag 140. In the example depicted in FIG. 1, the social media status indicator 145 can be assigned to the element 110. The user can place the social media status indicator 145 proximate to the element 110, or anywhere else in the portion 105 of the content 100. The social media status indicator 145 can be implemented as a bar, an outline around one or more elements 110-125, or as some other visual feature. The presentation object 135 can dynamically update the social media status indicator 145 to indicate a level of popularity and/or responses to generated social media messages which include one or more of the elements 110-125, for example the element 110. In illustration, presentation object 135 can grow or move a status bar 150 in the social media status indicator 145.

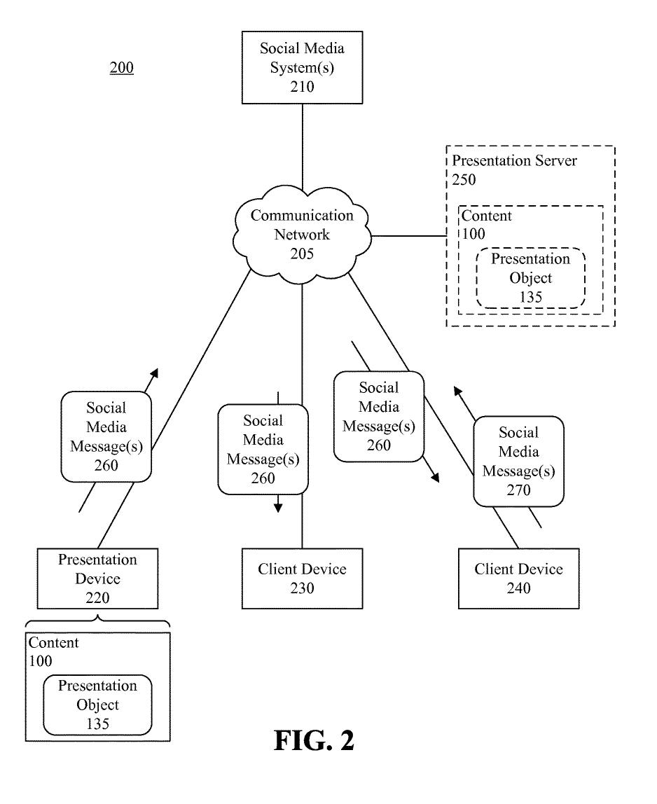

FIG. 2 is a block diagram illustrating an example of a network data processing system 200. The network data processing system 200 contains at least one communication network 205. The communication network 205 is the medium used to provide communications links between various devices and data processing systems connected together within network data processing system 200. The communication network 205 may include connections, such as wire, wireless communication links, or fiber optic cables. The communication network 205 may be implemented as, or include, any of a variety of different communication technologies such as a Wide Area Network (WAN), a Local Area Network (LAN), a wireless network, a mobile or cellular network, a Virtual Private Network (VPN), the Internet, the Public Switched Telephone Network (PSTN), or the like.

The network data processing system 200 also can include one or more social media systems 210, a presentation device 220 and a plurality of client devices 230, 235, each of which may be coupled to the communication network 205. Each social media system 210 may be implemented as one or more data processing systems (e.g., servers), each including at least one processor and memory, executing suitable operational software to support the sharing of social media messages, as is known in the art. The presentation device 220 can be configured to present the content 100 to an audience. In one arrangement, the presentation device 220 can execute the presentation application 130 of FIG. 1 to present the content 100, though the present arrangements are not limited in this regard.

Optionally, for example in an arrangement in which the presentation device 220 does not locally store the content 100, the network data processing system 200 also can include a presentation server 250 that stores the content 100, which may include the presentation object 135, either locally or to a coupled computer readable storage medium. Further, if the presentation device 220 stores the content 100, but not the presentation object 135 (e.g., the presentation object 135 is not embedded in the file for the content 100 or provided as a plugin to a presentation application installed on the presentation device 220), the presentation server 250 can store the presentation object 135. In another arrangement, the presentation device 220 can store the presentation object 135, and the presentation server 250 can store a companion presentation object (not shown) to which the presentation object 135 communicatively links to provide various functionality described herein.

In operation, the presentation device 220 or the presentation server 250 can execute the presentation object 135 to process the content 100, before, during and after presentation of the content to an audience by the presentation device 220. Such processing can include identifying tags in the content 100 indicating that social media messages 260 are to be automatically generated and communicated to one or more social media systems 210. Such processing also can include identifying, based on various parameters assigned to the tags, when the social media messages 260 are to be automatically generated and communicated, and to which social media systems 210 the social media messages 260 are to be communicated to be shared with various people, for example as posts in the social media systems 210 that are followed by the various people (e.g., contacts associated with one or more particular entities).

In illustration, the presentation object 135 can automatically monitor the aforementioned timeline and a duration of time between a present time and a time when the presentation of the content 100 to the audience is scheduled to begin. Responsive to the presentation object 135 identifying that the time line indicates that a social media message 260 is to be generated and communicated prior to presentation of the content 100, for example at a predetermined time or at a time that is a predetermined duration of time prior to the time when the presentation of the content to the audience is scheduled to begin, the presentation object 135 can automatically generate and communicate the social media message 260, via the communication network 205, to one or more of the social media systems 210 accordingly as a post or posts to be shared with various people. The various people can access the social media message 260 via respective client devices 230, 240. For example, the people can log into to the social media system(s) 210 to access the social media message 260, or the client devices 230, 240 can subscribe to the social media system(s) 210 and receive the social media message 260 according to the subscription.

In one example, the timeline may specify information relating to the content 100, but may or may not include any tagged elements. The presentation object 135 can include in the social media message 260 the specified information with or without elements of the content 100. In the case that a tag is not specified for a particular social media message 260 to be communicated, the social media system(s) 210 to which the social media message 160 to be communicated can be specified by the user in the timeline.

In an example in which the timeline may specify tags, the presentation object 135 can parse the content 100 to identify the tag(s). Based on the identified tag(s), the presentation object 135 can identify the element(s) to which the tag(s) is/are assigned. The presentation object 135 also can identify, based on the tag(s), the social media system(s) 210 to which the social media message 260 is to be communicated. The presentation object 135 can automatically generate the social media message 260 and include in the social media message 260 the element(s) corresponding to the identified tag(s), and communicate the social media message 260, via the communication network 205, to the identified social media system(s) 210 as a post or posts to be shared with various people. The social media message 260 also can include any other information specified by the user to include in that social media message 260.

Further, responsive to the presentation object 135 identifying that the time line indicates that a social media message 260 corresponding to one or more tags in the content 100 is to be automatically generated and communicated when presentation of the content 100 commences, the presentation object 135 can automatically monitor the content 100 for commencement of presentation of the content 100. Responsive to identifying commencement of presentation of the content 100, the presentation object 135 can automatically generate, in real time, and communicate, in real time, via the communication network 205, one or more social media messages 260 in a manner similar to one or more of the above examples.

During presentation of the content 100 to an audience, the presentation object 135 can monitor, in real time, the presentation to identify the presentation advancing from one portion of the content 100 to a another portion of the content 100 (e.g., a next portion). For example, the presentation object 135 can identify the presentation advancing from one page or slide to another page or slide. Responsive to identifying the presentation advancing from one portion of the content 100 to another, the presentation object 135 can determine, in real time, whether at least one element of the other portion of the content 100 is assigned a tag, for example a tag assigned a type “social media.” If so, the presentation object 135 can automatically generate, in real time, a corresponding social media message 260, and communicate the social media message 260, in real time, via the communication network 205, to the social media system(s) 210 for sharing with various people, for example as previously described.

The presentation object 135 also can automatically monitor, in real time, for a completion of the presentation of the content 100 to the audience. Responsive to identifying the completion of the presentation of the content 100 to the audience, the presentation object 135 can automatically generate a social media message 260 comprising information relating to the content 100 and/or tagged elements and communicate the social media message 160 to the social media system(s) 210 for sharing with the people. In one non-limiting example, the social media message 260 can be communicated at a time that is a predetermined duration of time after a time when presentation of the content to the audience is completed. Moreover, the presentation object 135 can re-communicate the social media message 160 a plurality of times, for example at predetermined time intervals or at a specified frequency, to the social media system(s) 210, thereby reinforcing topics being shared.

Before or during presentation of the content 100, people receiving the social media messages 260 may generate additional social media messages 270 which pertain to the content 100 being presented to the audience. For example, people may reply to one or more of the social media messages 260 and/or re-post such social media messages 260. The presentation object 135 can automatically monitor, in real time, the social media system(s) 210 for the additional social media messages 270. The presentation object 135 can process each of the additional social media messages 270 and, based on such processing, perform any number of functions.

In illustration, the presentation object 135 can automatically monitor a total number of social media messages 270 responding to the social media messages 260 and/or re-posting the social media messages 260. Further, the presentation object 135 can apply natural language processing (NLP) and semantic analysis on information contained in each of the additional social media messages 270. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input.

Based on processing the additional social media messages 270, the presentation object 135 can determine, in real time, the popularity of the information communicated in the social media messages and the sentiment of the people receiving the social media messages 260. The social media messages 270 also can identify trends in popularity/sentiment as further social media messages 260 are communicated and additional social media messages 270 continue to be identified and processed. In one arrangement, the popularity/sentiment analysis performed by the presentation object 135 can be performed on specific elements of the content 100, for example if parameters for those elements are set to indicate that such analysis is to be performed.

For example, if a particular element is included in a particular social media message 260, the presentation object 135 can identify and process additional social media messages 270 generated in response to that particular social media message 260. Further, the presentation object 135 can dynamically update the content 100 to indicate the results of such processing. For example, the presentation object 135 can dynamically update the previously described social media status indicator 145 of FIG. 1 to provide such indication. In illustration, based on processing the additional social media messages 270, the presentation object 135 can update the social media status indicator to show an increase in the interest as more social media messages 270 are detected.

In another example, a portion of the content 100 including an element assigned a tag can have a field proximate to the element in which the presentation object 135 can enter snippets of one or more of the social media messages 270. For example, using NLP and semantic analysis, the presentation object 135 can identify snippets within the social media messages 270 that reflect a positive sentiment toward a particular element, and include the snippets in the field. In illustration, a snippet for a first social media message 270 can be presented in the field. The presentation object 135 can leave that snippet in the field for a certain period of time. After the period of time has elapsed, the presentation object 135 can update the field with another snippet from another social media message 270.

In another aspect of the present arrangements, the presentation object 135 can automatically generate and communicate further social media messages (not shown) in response to the social media messages 270. For example, a user generating the content 100 can anticipate that certain questions about the content 100 may be asked. The user can define social media messages to be automatically generated and communicated in response to additional social media messages 270 being identified that include certain words, phrases or topics, which can be identified using NLP and semantic analysis. The further social media messages can include any of a variety of information, for example, standard responses (e.g., “good question, check out www.yyxm.com/newrevolution for more information”), details pertaining to one or more of the elements presented in the content 100, etc.

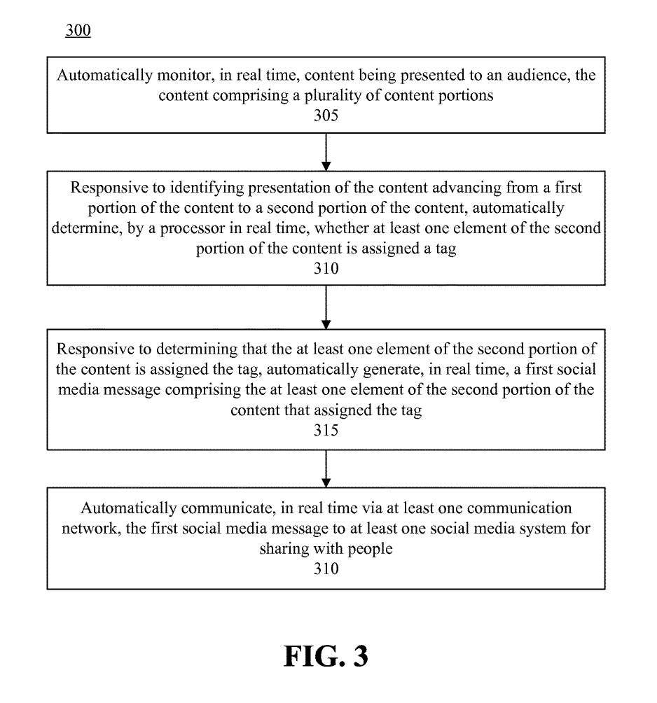

FIG. 3 is a flow chart illustrating an example of a method 300 of communicating a social media message relating to content being presented to an audience. At step 305, a presentation object 135 can automatically monitor, in real time, content being presented to an audience, the content comprising a plurality of content portions. At step 310, responsive to identifying presentation of the content advancing from a first portion of the content to a second portion of the content, the presentation object, executed by a processor, can automatically determine whether at least one element of the second portion of the content is assigned a tag. At step 315, responsive to determining that the at least one element of the second portion of the content is assigned the tag, the presentation object can automatically generate, in real time, a first social media message comprising the at least one element of the second portion of the content that assigned the tag. At step 310, the presentation object can automatically communicate, in real time via at least one communication network, the first social media message to at least one social media system for sharing with people.

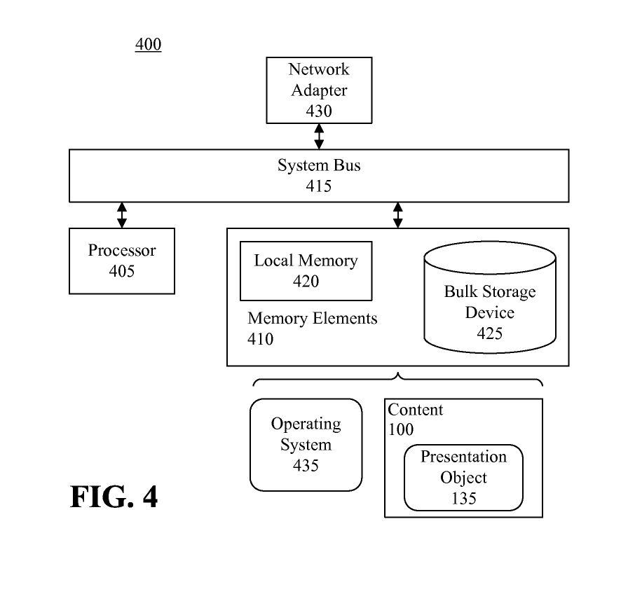

FIG. 4 is a block diagram illustrating example architecture for a data processing system 400. The data processing system 400 can be implemented as the presentation device 220 or the presentation server 250 of FIG. 2.

The data processing system 400 can include at least one processor 405 (e.g., a central processing unit) coupled to memory elements 410 through a system bus 415 or other suitable circuitry. As such, the data processing system 400 can store program code within the memory elements 410. The processor 405 can execute the program code accessed from the memory elements 410 via the system bus 415. It should be appreciated that the data processing system 400 can be implemented in the form of any system including a processor and memory that is capable of performing the functions and/or operations described within this specification. For example, the data processing system 400 can be implemented as one or more hardware servers.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The data processing system 400 also can include one or more cache memories (not shown) that provide temporary storage of at least some program code in order to reduce the number of times program code must be retrieved from the bulk storage device 425 during execution.

One or more network adapters 430 can be coupled to data processing system 400 to enable the data processing system 400 to become coupled to other systems, computer systems, remote printers, and/or remote storage devices through intervening private or public networks. Modems, cable modems, transceivers, and Ethernet cards are examples of different types of network adapters 430 that can be used with the data processing system 400. In an arrangement in which the data processing system 400 is implemented as the presentation device 220, additional input/output devices (not shown), such as a display, a pointing device, a keyboard, a projector and/or an audio system can be coupled to the data processing system 400 either directly or through intervening I/O controllers.

As pictured in FIG. 4, the memory elements 410 can store an operating system 435, the content 100 and the presentation object 135. Being implemented in the form of executable program code, the operating system 435 and the presentation object 135 can be executed by the processor 405. For example, the processor can execute the presentation object 135 within a computing environment provided by the operating system 435 in order to perform the processes described herein that are performed by the presentation object 135. As such, the operating system 435 and the presentation object 135 can be considered part of the data processing system 400. Moreover, the operating system 435 and the presentation object 135 are functional data structures that impart functionality when employed as part of the data processing system 400. Further, the content 100 is a functional data structure that imparts functionality when processed by the data processing system 400.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
automatically monitoring, in real time, content being presented to an audience, the content comprising a plurality of content portions;
responsive to identifying presentation of the content advancing from a first portion of the content to a second portion of the content, automatically determining, by a processor in real time, whether at least one element of the second portion of the content is assigned a tag;
responsive to determining that the at least one element of the second portion of the content is assigned the tag, automatically generating, in real time, a first social media message comprising the at least one element of the second portion of the content that assigned the tag; and
automatically communicating, in real time, via at least one communication network, the first social media message to at least one social media system for sharing with people.

2. The method of claim 1, further comprising:
automatically monitoring a duration of time between a present time and a first time when the presentation of the content to the audience is scheduled to begin; and
at a second time that is a predetermined duration of time prior to the first time when the presentation of the content to the audience is scheduled to begin, automatically communicating a second social media message to the at least one social media system for sharing with the people, wherein the second social media message comprises information relating to the content presented to the audience.

3. The method of claim 1, further comprising:
automatically monitoring a for a completion of the presentation of the content to the audience;
responsive to identifying the completion of the presentation of the content to the audience, automatically generating a second social media message comprising information relating to the content presented to the audience; and
communicating the second social media message to the at least one social media system for sharing with the people.

4. The method of claim 3, wherein automatically communicating the second social media message to the at least one social media system for sharing with the people comprises:
automatically communicating the second social media message to the at least one social media system at a second time that is a predetermined duration of time after a first time when presentation of the content to the audience is completed.

5. The method of claim 1, further comprising:
monitoring, in real time, the at least one social media system for additional social media messages, generated by the people, which pertain to the content being presented to the audience; and
automatically updating, by the processor in real time, at least one portion of the content being presented to the audience to include information pertaining to at least one of the additional social media messages.

6. The method of claim 1, further comprising:
automatically monitoring and processing a plurality of other social media messages responding to or re-sharing the first social media message; and
responsive to processing the plurality of other social media messages, indicating results of the processing by dynamically updating a social media status indicator assigned to the at least one element and depicted in the second portion of the content.

7. The method of claim 1, further comprising:
presenting to a user a timeline indicating the tag and a plurality of additional tags, wherein the timeline is configured to receive inputs from the user to define when the first social media message and other social media messages corresponding to the additional tags are to be automatically generated and communicated.

8. A system, comprising:
a processor programmed to initiate executable operations comprising:
automatically monitoring, in real time, content being presented to an audience, the content comprising a plurality of content portions;
responsive to identifying presentation of the content advancing from a first portion of the content to a second portion of the content, automatically determining, in real time, whether at least one element of the second portion of the content is assigned a tag;
responsive to determining that the at least one element of the second portion of the content is assigned the tag, automatically generating, in real time, a first social media message comprising the at least one element of the second portion of the content that assigned the tag; and
automatically communicating, in real time, via at least one communication network, the first social media message to at least one social media system for sharing with people.

9. The system of claim 8, the executable operations further comprising:
automatically monitoring a duration of time between a present time and a first time when the presentation of the content to the audience is scheduled to begin; and
at a second time that is a predetermined duration of time prior to the first time when the presentation of the content to the audience is scheduled to begin, automatically communicating a second social media message to the at least one social media system for sharing with the people, wherein the second social media message comprises information relating to the content presented to the audience.

10. The system of claim 8, the executable operations further comprising:
automatically monitoring a for a completion of the presentation of the content to the audience;
responsive to identifying the completion of the presentation of the content to the audience, automatically generating a second social media message comprising information relating to the content presented to the audience; and
communicating the second social media message to the at least one social media system for sharing with the people.

11. The system of claim 10, wherein automatically communicating the second social media message to the at least one social media system for sharing with the people comprises:
automatically communicating the second social media message to the at least one social media system at a second time that is a predetermined duration of time after a first time when presentation of the content to the audience is completed.

12. The system of claim 8, the executable operations further comprising:
monitoring, in real time, the at least one social media system for additional social media messages, generated by the people, which pertain to the content being presented to the audience; and
automatically updating, by the processor in real time, at least one portion of the content being presented to the audience to include information pertaining to at least one of the additional social media messages.

13. The system of claim 8, the executable operations further comprising:
automatically monitoring and processing a plurality of other social media messages responding to or re-sharing the first social media message; and
responsive to processing the plurality of other social media messages, indicating results of the processing by dynamically updating a social media status indicator assigned to the at least one element and depicted in the second portion of the content.

14. The system of claim 8, the executable operations further comprising:
presenting to a user a timeline indicating the tag and a plurality of additional tags, wherein the timeline is configured to receive inputs from the user to define when the first social media message and other social media messages corresponding to the additional tags are to be automatically generated and communicated.

15. A computer program product comprising a computer readable storage medium having program code stored thereon, the program code executable by a processor to perform a method comprising:
automatically monitoring, by the processor in real time, content being presented to an audience, the content comprising a plurality of content portions;
responsive to identifying presentation of the content advancing from a first portion of the content to a second portion of the content, automatically determining, by the processor in real time, whether at least one element of the second portion of the content is assigned a tag;
responsive to determining that the at least one element of the second portion of the content is assigned the tag, automatically generating, by the processor in real time, a first social media message comprising the at least one element of the second portion of the content that assigned the tag; and
automatically communicating, by the processor in real time, via at least one communication network, the first social media message to at least one social media system for sharing with people.

16. The computer program product of claim 15, the method further comprising:
automatically monitoring a duration of time between a present time and a first time when the presentation of the content to the audience is scheduled to begin; and
at a second time that is a predetermined duration of time prior to the first time when the presentation of the content to the audience is scheduled to begin, automatically communicating a second social media message to the at least one social media system for sharing with the people, wherein the second social media message comprises information relating to the content presented to the audience.

17. The computer program product of claim 15, the method further comprising:
automatically monitoring a for a completion of the presentation of the content to the audience;
responsive to identifying the completion of the presentation of the content to the audience, automatically generating a second social media message comprising information relating to the content presented to the audience; and
communicating the second social media message to the at least one social media system for sharing with the people.

18. The computer program product of claim 17, wherein automatically communicating the second social media message to the at least one social media system for sharing with the people comprises:
automatically communicating the second social media message to the at least one social media system at a second time that is a predetermined duration of time after a first time when presentation of the content to the audience is completed.

19. The computer program product of claim 15, the method further comprising:
monitoring, in real time, the at least one social media system for additional social media messages, generated by the people, which pertain to the content being presented to the audience; and
automatically updating, by the processor in real time, at least one portion of the content being presented to the audience to include information pertaining to at least one of the additional social media messages.

20. The computer program product of claim 15, the method further comprising:
automatically monitoring and processing a plurality of other social media messages responding to or re-sharing the first social media message; and
responsive to processing the plurality of other social media messages, indicating results of the processing by dynamically updating a social media status indicator assigned to the at least one element and depicted in the second portion of the content.
